(19) United States
(12) Patent Application Publication
(10) Pub. No.: US 2009/0043014 A1
(43) Pub. Date: Feb. 12, 2009

(54) RUBBER COMPOSITION FOR TIRE AND ITS PRODUCING METHOD

(75) Inventors: Hiroaki Narita, Osaka (JP); Ikuo Ihara, Osaka (JP); Takashi Miyasaka, Osaka (JP); Hirofumi Hayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/184,397

(22) Filed: Aug. 1, 2008

(30) Foreign Application Priority Data
Aug. 9, 2007 (JP) 2007-207816

(51) Int. Cl. C08J 3/22

(52) U.S. Cl. 523/351

(57) ABSTRACT

A rubber composition for tire, which combines low heat build-up properties and breakage property in high level, reduces fuel consumption of a tire, and has excellent durability and good processability is provided. The rubber composition for tire is obtained by kneading a diene rubber component, sulfur and a pyrithione metal salt to obtain a rubber mixture, and adding and kneading a vulcanization accelerator in a post-mixing step using the rubber mixture. The pyrithione metal salt can use a compound represented by the following formula (1):

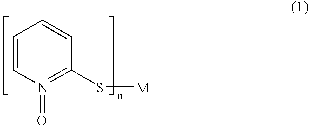

wherein n is 1 or 2, and M represents Zn, Cu, Na or Ca.

### CROSS-REFERENCE TO RELATED APPLICATIONS

This application is based upon and claims the benefit of priority from the prior Japanese Patent Application No. 2007-207816, filed on August 9, 2007; the entire contents of which are incorporated herein by reference.

### BACKGROUND

The present invention relates to a rubber composition for tire, and more particularly it relates to a rubber composition for tire, having an enhanced low rolling resistance by improving heat build-up properties while maintaining breakage property of a tire.

In recent years, the demand for low fuel consumption of automobiles is increasing, and reduction of rolling resistance of a tire is strongly demanded. It is known that rolling resistance is related to heat build-up properties of a rubber composition, and it is effective to reduce hysteresis loss of a rubber, that is, to suppress loss factor (tan δ) of a rubber composition low.

Various technologies for suppressing heat build-up properties of a rubber composition are proposed. For example, JP-A-2005-146076 discloses a rubber composition for side tread, comprising 100 parts by weight of a vulcanizable rubber containing 65% by weight or more of a natural rubber and a polybutadiene rubber, 30 to 80 parts by weight of the total of silica and/or carbon black having nitrogen adsorption specific surface area (N₂SA) of 20 to 85 m²/g, and 0.1 to 10 parts by weight of a specific cyclic polysulfide, the composition having high hardness, strength and elongation, and suppressing rise of tan δ.

JP-A-2006-151259 discloses that a rubber composition containing a modified natural rubber obtained by graft-polymerizing a polar group-containing monomer on a natural rubber latex, and solidifying and drying it, the composition having both of excellent low heat build-up and high breakable resistance properties.

JP-A-2005-15638 discloses that a rubber composition for tire, comprising 100 parts by weight of a diene rubber comprising 70 to 20 parts by weight of a natural rubber and/or an isoprene rubber and 30 to 80 parts by weight of a butadiene rubber, 0.20 to 3.0 parts by weight of zinc bis(1-hydroxy-2 (1H)-pyridinethionate-O,S), and 60 to 90 parts by weight of carbon black containing an HAF grade and having a particle diameter smaller than it, the composition having both of abrasion resistance and low heat build-up properties.

A rubber composition for tire is required to have low heat build-up and high breakage property in order to ensure rolling resistance and tire durability. To respond to this requirement, a method in which in a formulation mainly comprising a natural rubber component, SBR and BR are blended with a natural rubber to decrease tan δ of a rubber composition as possible, thereby suppressing heat build-up of a rubber composition itself is conventionally investigated. Where a proportion of a natural rubber is increased, breakage strength is improved, but there is the tendency that low build-up properties are not obtained. Thus, it was difficult to combine low heat build-up properties and breakage property in high level.

### SUMMARY

In view of the above point, the present invention has an object to provide a rubber composition for tire, which combines low heat build-up properties and breakage property in high level, reduces fuel consumption of a tire, and has excellent durability and good processability.

The present invention has been made based on the finding that heat build-up properties can be improved by using a masterbatch obtained by previously and simultaneously mixing sulfur and a pyrithione metal salt with a diene rubber component, in a rubber composition.

The present invention relates to a rubber composition for tire, obtained by kneading a diene rubber component, sulfur and a pyrithione metal salt to obtain a rubber mixture, and adding and kneading a vulcanization accelerator in a post-mixing step using the rubber mixture.

It is preferred that the rubber mixture comprises 100 parts by weight of the diene rubber component, 0.1 to 1.0 part by weight of the sulfur and 0.2 to 5.0 parts by weight of the pyrithione metal salt.

Furthermore, it is preferred that a reinforcing filler is added to and mixed with the rubber mixture in the post-mixing step.

The pyrithione metal salt can use a compound represented by the following formula (1):

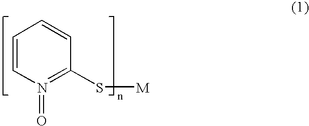

wherein n is 1 or 2, and M represents Zn, Cu, Na or Ca.

According to the rubber composition for tire of the present invention, in a diene rubber formulation mainly comprising a natural rubber component, low heat build-up properties and breakage property are combined in high level, thereby reducing fuel consumption of a tire and simultaneously having excellent durability, and furthermore, process stabilization can be attained by maintaining processability good.

### DETAILED DESCRIPTION

The rubber composition for tire of the present invention is obtained by kneading a diene rubber component, sulfur and a pyrithione metal salt to obtain a rubber mixture in a first mixing step (pre-mixing), and adding a vulcanization accelerator to the rubber mixture, followed by kneading the resulting mixture, in a mixing step of a second mixing step or later.

Examples of the diene rubber used as a rubber component include natural rubbers, and dienic synthetic rubbers such as an isoprene rubber, a butadiene rubber or a styrene-butadiene rubber. Those may be used alone or as mixtures of two or more thereof in optional proportions.

In the present invention, the rubber component contains the natural rubber or isoprene rubber in an amount of preferably 60 parts by weight or more, and more preferably 70 parts by weight or more, per 100 parts by weight of the rubber component. This makes it easy to ensure properties such as breakage strength, abrasion resistance or fatigue resistance of the rubber composition.

When the dienic synthetic rubber is blended with a natural rubber, a butadiene rubber having excellent impact resilience, low temperature properties, flexural fatigue resistance and the like, particularly a high cis-type butadiene rubber having a cis-1,4-bond content of 95% or more, and a solution styrene-butadiene rubber having aging resistance, heat resistance, abrasion resistance and the like are preferably used. The production of those synthetic rubbers may be an emulsion polymerization or a solution polymerization. Furthermore, a microstructure is not particularly limited.

Examples of the sulfur include powdered sulfur, precipitated sulfur, colloidal sulfur, insoluble sulfur and oil-treated sulfur. Those sulfurs may be used as mixtures of two or more thereof.

The pyrithione metal salt used in the rubber composition of the present invention can use a compound represented by the following formula (1):

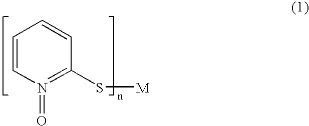

wherein n is 1 or 2, and M represents Zn, Cu, Na or Ca.

The pyrithione metal salt represented by the formula (1) includes zinc pyrithione, copper pyrithione and sodium pyrithione. For example, the zinc pyrithione includes zinc [1-hydroxy-2(1H)-pyridinethionate-O,S] (ZPNO). The zinc pyrithione is produced by reacting 1-hydroxy-2-pyridinethione or its soluble salt with a zinc salt (such as ZnSO₄), thereby forming zinc pyrithione precipitates, as described in, for example, U.S. Pat. No. 2,809,971, and ZPNO is commercially available as a carbon coupling agent, a product of FLEXSYS.

Blending the ZPNO can improve heat build-up properties without deterioration of properties of abrasion resistance, heat aging resistance, fatigue resistance and the like.

It is preferred in the present invention that the rubber mixture obtained in the first mixing step comprises 100 parts by weight of the diene rubber component, 0.1 to 1.0 part by weight of the sulfur, and 0.2 to 5.0 parts of the pyrithione metal salt.

Where only the rubber component and the sulfur are mixed, improvement effect in heat build-up properties and processability are not obtained. The improvement effect in heat build-up properties and processability is developed by simultaneously adding and kneading the pyrithione metal salt.

Where the amount of the sulfur added is less than 0.1 part by weight, it is difficult to develop the desired effect, and where the amount exceeds 1.0 part by weight, there is the great possibility that crosslinking reaction begins due to heat build-up during kneading. Furthermore, where the amount of the pyrithione metal salt added is less than 0.2 part by weight, improvement effect in heat build-up properties and processability is insufficient, and where the amount exceeds 5.0 parts by weight, heat build-up properties are good, but rubber hardness of a rubber mixture is increased, causing deterioration of various properties such as breakage property of the final rubber composition.

In the first mixing step, when a reinforcing filler such as carbon black or silica is simultaneously mixed, ZPNO and the filler are reacted and bonded to cure the rubber mixture, resulting in deterioration of kneadability and processability in the post-steps. Therefore, it is preferred that the reinforcing filer is added and mixed in a second mixing step or later. However, as the case may be, the reinforcing filler may be added and mixed in the first mixing step.

A vulcanization accelerator added and mixed in the mixing step of the second mixing step or later can use any vulcanization accelerator without limiting its kind. Examples of the vulcanization accelerator that can be used include sulfene amide type vulcanization accelerators such as N-cyclohexyl-2-benzothiazylsulfene amide (CZ), N-tert-butylbenzothiazole-2-sulfene amide (NS) or N-oxydiethylene-2-benzothiazolesulfene amide (OBS); thiuram type vulcanization accelerators such as tetramethylthiuram disulfide (TT) or tetrabutylthiuram disulfide (TBT); aldehyde/ammonia type vulcanization accelerators such as hexamethylene tetramine; guanidine type vulcanization accelerators such as 1,3-diphenylguanidine (D); and thiazole type vulcanization accelerators such as 2-mercaptobenzothiazole (M) or dibenzothiadyldisulfide (DM).

The vulcanization accelerator is used in an amount of about 0.3 to 5 parts by weight, and preferably 0.5 to 3 parts by weight, per 100 parts by weight of the rubber component. Where the amount of the vulcanization accelerator used is less than 0.3 part by weight, vulcanization rate becomes slow, resulting in decrease of productivity, and where the amount exceeds 5 parts by weight, scorch is liable to occur. The vulcanization accelerator may be used as mixtures of two or more thereof.

Examples of the reinforcing filler used in the rubber composition of the present invention include fillers such as carbon black, silica, calcium carbonate, clay and talc.

The carbon black used is not particularly limited. For example, carbon black having colloidal properties of nitrogen adsorption specific surface area (N₂SA) of 25 to 130 m²/g and DBP oil absorption of 80 ml/100 g or more can be used.

Examples of such a carbon black include various grades of N110, N220, N330, N550 or N660 in ASTM number.

The amount of the carbon black blended is about 20 to 80 parts by weight per 100 parts by weight of the rubber component. Where the amount of the carbon black blended is less than 20 parts by weight, reinforcing effect is deficient, and breakage property and abrasion resistance are decreased. On the other hand, where the amount exceeds 80 parts by weight, heat build-up properties deteriorate, and the effect for reducing rolling resistance tends to be decreased.

Examples of the silica include silica having colloidal properties of BET specific surface area (BET) of 150 m²/g or less and DBP oil absorption of 190 ml/100 g or less. Using such silica having large particle diameter and small structure can improve processability and additionally can reduce rolling resistance of a tire.

The amount of silica blended is 10 to 50 parts by weight per 100 parts by weight of the rubber component. Where the amount of silica blended is less than 10 parts by weight, the effect for reducing rolling resistance cannot sufficiently be developed. The preferred amount of silica blended is 20 to 40 parts by weight.

The silica is not particularly limited so long as the above colloidal properties are satisfied. Examples of the silica used include wet silica (hydrous silicic acid), dry silica (anhydrous silicic acid), calcium silicate and aluminum silicate. Above all, wet silica having both of breakage property and low rolling resistance is preferred, and such is further preferred from the point of excellent productivity. Commercially available products such as NIPSEAL AQ, a product of Tosoh Silica Corporation, and TOKUSEAL, a product of Tokuyama Corp., can be used.

The silica can further use a surface-treated silica obtained by surface-treating with amines or organic polymers to improve affinity with a polymer.

Where silica is used, it is preferred to use a silane coupling agent in an amount of 2to20% by weight, and preferably 2 to 15% by weight, based on the weight of the silica. Examples of the silane coupling agent used include sulfur-containing silane coupling agents such as bis(3-triethoxysilylpropyl)tetrasulfide or bis(3-triethoxysilylpropyl)disulfide; and 3-trimethoxysilylpropylbenzothiazole tetrasulfide.

In addition to the above components, the rubber composition of the present invention can contain various blending agents such as process oils, zinc oxide, stearic acid, waxes, aging inhibitors, vulcanization aids or resins, that are generally used in a tire industry, according to need in an amount such that the advantage of the invention is not impaired.

The rubber composition for tire of the present invention as above is prepared by the conventional methods using kneading machines for rubber such as Banbury mixer or a kneader.

Specifically, in a first mixing step (A), the diene rubber component, the sulfur and the pyrithione metal salt are kneaded to prepare a rubber mixture (masterbatch). The reinforcing filler may simultaneously be mixed. In a second mixing step (B), a rubber component, the sulfur or the pyrithione metal salt to be additionally added to the masterbatch if necessary, the reinforcing filler such as carbon black, and other blending agent such as zinc oxide, aging inhibitor or stearic acid are added to the masterbatch and the resulting mixture is kneaded. In a third mixing step (C), a rubber component, the sulfur or the pyrithione metal salt to be further additionally added if necessary, the vulcanization accelerator and a scorch inhibitor are added to the mixture prepared above, and the resulting mixture is kneaded. Thus, a final rubber composition is prepared. Furthermore, the above step (B) and step (C) can be conducted in the same step, thereby preparing the final mixture in two steps.

The rubber composition for tire obtained by the present invention is not particularly limited in its use, and can be applied to each site of a tire, such as a tread part, a side wall part, a bead part or a rubber for covering a tire cord, of pneumatic tires for various uses and having various sizes, such as tires for passenger cars and large-sized tires for tracks or buses.

### EXAMPLES

The present invention is described by the following Examples, but the invention is not limited to those Examples.

100 parts by weight of the total of a natural rubber and a butadiene rubber, and the blending components shown below were kneaded according to the formulation shown in Table 1 using a 20 liters volume sealed Banbury mixer to prepare a masterbatch in a first mixing step. Using this masterbatch, a final rubber composition was prepared by second and third mixing steps.

### Rubber Component

Natural rubber: STR20

Butadiene rubber: JSR BR01, a product of JSR Corporation

### Blending Component

Sulfur: 5% oil-treated powdered sulfur, a product of Tsurumi Chemical Co., Ltd.

Zinc pyrithione (zinc bis[1-hydroxy-2 (1H)-pyridine-thionate-O,S] (ZPNO)): a product of FLEXSYS

Peptizer: NOCTIZER SD, a product of Ouchi Shinko Chemical Industrial Co., Ltd.

Carbon black: SHOW BLACK N220, a product of Showa Cabot K.K.

Vulcanization accelerator CZ: SOXINOL CZ, a product of Sumitomo Chemical Co., Ltd.

Scorch inhibitor: SANTOGARD PVI, a product of FLEXSYS

Zinc oxide: Zinc White #1, a product of Mitsui Mining & Smelting Co., Ltd.

Aging inhibitor: ANTIGEN 6C, a product of Sumitomo Chemical Co., Ltd.

Stearic acid: LUNAX S-25, a product of Kao Corporation

Wax: OKERIN 2122H, a product of Honeywell

Regarding each rubber composition obtained, 300% modulus as an index of breakage property and tan δ as an index of heat build-up properties were evaluated by the following methods. The results obtained are shown in Table 1.

### 300% Modulus

Measured by a tensile test (using No. 3 Dumbbell) according to JIS K6251, and indicated by an index as Comparative Example 1 being 100. Larger value is good.

Tan δ

Measured under the conditions of frequency of 50 Hz, dynamic strain of 2% and 80° C. using RHEOSPECTROMETER E-4000, a product of UBM, and indicated by an index as Comparative Example 1 being 100. Smaller value means small heat build-up and is good.

TABLE 1

| | | Com. | Com. | Com. | Com. | Com. | | | | | |
|---|---|---|---|---|---|---|---|---|---|---|---|
| | | Ex. 1 | Ex. 2 | Ex. 3 | Ex. 4 | Ex. 5 | Ex. 1 | Ex. 2 | Ex. 3 | Ex. 4 | Ex. 5 |
| First | Natural rubber | | 100 | 100 | 100 | 100 | 100 | 100 | 100 | 100 | 80 |
| mixing | Butadiene rubber | | | | | | | | | | 20 |
| step | Sulfur | | | | 0.5 | 0.5 | 0.5 | 0.5 | 0.5 | 0.5 | 0.5 |
| | ZPNO | | | | | 6 | 0.3 | 2 | 2 | 1 | 2 |
| | Carbon black | | | 40 | | | | | 40 | | |
| | Peptizer | | 0.04 | | | | | | | | |
| Second | Rubber component | *2 | *1 | *1 | *1 | *1 | *1 | *1 | *1 | *1 | *1 |
| mixing | Carbon black | 40 | 40 | | 40 | 40 | 40 | 40 | | 40 | 40 |
| step | Sulfur | | | | | | | | | | |
| | ZPNO | | | | | | | | | 1 | |
| | Zinc oxide | 3.0 | 3.0 | 3.0 | 3.0 | 3.0 | 3.0 | 3.0 | 3.0 | 3.0 | 3.0 |
| | Aging inhibitor | 1.4 | 1.4 | 1.4 | 1.4 | 1.4 | 1.4 | 1.4 | 1.4 | 1.4 | 1.4 |
| | Stearic acid | 1.0 | 1.0 | 1.0 | 1.0 | 1.0 | 1.0 | 1.0 | 1.0 | 1.0 | 1.0 |
| | Wax | 0.5 | 0.5 | 0.5 | 0.5 | 0.5 | 0.5 | 0.5 | 0.5 | 0.5 | 0.5 |
| Third | Vulcanization | 1.3 | 1.3 | 1.0 | 1.3 | 1.2 | 1.3 | 1.1 | 1.3 | 1.1 | 1.1 |
| mixing | accelerator | | | | | | | | | | |
| step | Sulfur | 1.6 | 1.6 | 1.6 | 1.1 | 1.1 | 1.1 | 1.1 | 1.1 | 1.1 | 1.1 |
| | ZPNO | | | 2 | | | | | | | |
| | Scorch inhibitor | 0.2 | 0.2 | 0.2 | 0.2 | 0.2 | 0.2 | 0.2 | 0.2 | 0.2 | 0.2 |
| Results | 300% modulus (index) | 100 | 97 | 132 | 102 | 163 | 100 | 108 | 106 | 105 | 104 |
| | tan δ (index) | 100 | 101 | 90 | 97 | 80 | 95 | 80 | 78 | 79 | 89 |

*1: Masterbatch obtained in first mixing step is used.
*2: Comparative Example 1 uses 100 parts by weight of natural rubber.

As is seen from Table 1, the Examples according to the present invention can improve breakage property and heat build-up properties, and can enhance low fuel consumption property and durability performance of a tire, while maintaining good processability.

The rubber composition for tire of the present invention can be applied to each site of a tire, such as a tread part, a side wall part, a bead part or a rubber for covering a tire cord, of pneumatic tires for various uses and having various sizes.

What is claimed is:

1. A rubber composition for tire, obtained by kneading a diene rubber component, sulfur and a pyrithione metal salt to obtain a rubber mixture, and adding and kneading a vulcanization accelerator in a post-mixing step using the rubber mixture.

2. The rubber composition for tire as claimed in claim 1, wherein the rubber mixture comprises 100 parts by weight of the diene rubber component, 0.1 to 1.0 part by weight of the sulfur and 0.2 to 5.0 parts by weight of the pyrithione metal salt.

3. The rubber composition for tire as claimed in claim 1, wherein a reinforcing filler is added to and mixed with the rubber mixture in the post-mixing step.

4. The rubber composition for tire as claimed in claim 1, wherein the pyrithione metal salt is a compound represented by the following formula (1): 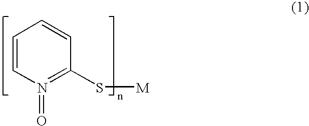
wherein n is 1 or 2, and M represents Zn, Cu, Na or Ca.

5. A method for producing a rubber composition for tire, comprising kneading a diene rubber component, sulfur and a pyrithione metal salt to obtain a rubber mixture, and adding and kneading a vulcanization accelerator in a post-mixing step using the rubber mixture.

6. The method for producing a rubber composition for tire as claimed in claim 5, wherein the rubber mixture comprises 100 parts by weight of the diene rubber component, 0.1 to 1.0 part by weight of the sulfur and 0.2 to 5.0 parts by weight of the pyrithione metal salt.

7. The method for producing a rubber composition for tire as claimed in claim 5, wherein a reinforcing filler is added to and mixed with the rubber mixture in the post-mixing step.

8. The method for producing a rubber composition for tire as claimed in claim 5, wherein the pyrithione metal salt is a compound represented by the following formula (1): 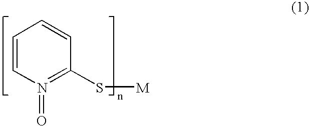
wherein n is 1 or 2, and M represents Zn, Cu, Na or Ca.
